(19) United States
(12) Patent Application Publication
(10) Pub. No.: US 2026/0065041 A1
(43) Pub. Date: Mar. 5, 2026

(54) NEUROMORPHIC PROCESSOR STRUCTURE FOR LAYER UNIT EVENT ROUTING OF SPIKING NEURAL NETWORK, AND CONTROL METHOD THEREFOR

(71) Applicant: IUCF-HYU (Industry-University Cooperation Foundation Hanyang University)

(72) Inventors: Doo Seok Jeong, Seoul (KR); Vladimir Kornijcuk, Seoul (KR); Changmin Ye, Seoul (KR)

(73) Assignee: IUCF-HYU (Industry-University Cooperation Foundation Hanyang University), Seoul (KR)

(21) Appl. No.: 19/107,191

(22) PCT Filed: Aug. 23, 2023
(86) PCT No.: PCT/KR2023/012516

§ 371 Date: Feb. 27, 2025

(30) Foreign Application Priority Data
Aug. 31, 2022 (KR) 10-2022-0110058

(51) Int. Cl. G06N 3/063

(52) U.S. Cl. CPC G06N 3/063

(57) ABSTRACT

Proposed are a neuromorphic processor structure for layer unit event routing of a spiking neural network, and a control method therefor. A layer unit event routing method of a spiking neural network, proposed in the present invention, comprises the steps of: optimizing a data structure for performing layer unit event routing by using a neuron address index method including a global index, a layer unit index, and a neuron group index; performing the layer unit event routing by using an LUT for each of the global index, the layer unit index, and the neuron group index; and compressing synapse weight data according to global address operations of the layer unit event routing for the neuron group index.

### TECHNICAL FIELD

The present disclosure relates to layer-centric event-routing architecture for digital neuromorphic processors with spiking neural networks.

### BACKGROUND

Spike Neural Network (SNN) is dynamic models that may extract features of time-varying data, particularly asynchronous event data. SNN is composed of spike neuron and unidirectional synapse. Spike neuron low-pass filters the input synaptic current to calculate a threshold membrane potential (state variable) that varies with time. When the membrane potential exceeds the spike threshold, the neuron emits a spike and the membrane potential is reset, which is called the Leaky Integrate-and-Fire (LIF) model. Often a synapse is modeled to low-pass filter an input spike and consequently output a time-varying synaptic current. The dynamic operation of these building blocks is a rich dynamic element of SNN.

Given that the SNN is a time-dependent model, implementation of the SNN includes the time domain. When implemented using general-purpose digital hardware such as central processing unit (CPU) and graphics processing unit (GPU), calculating the model in the discrete time domain results in a large computational complexity that scales with the number of time steps considered. Unfortunately, the computation over time is executed in a serial manner due to forward locking, so that the computation cannot be started at a given time step until the computation is completed at a previous time step. Therefore, the wall clock time is lengthened due to the large computational complexity. Nevertheless, the use of a GPU may greatly speed up the computation within a timestep, but it must consume a lot of power.

The solution is to accelerate computation and reduce power consumption over time using dedicated hardware called neuromorphic hardware. Initially, neuromorphic hardware was designed using analog mega integrated circuits to realize brain functions. Recent trends in neuromorphic hardware development highlight a shift from early brain-inspired hardware to deep learning-inspired. That is, SNN driven with neuromorphic hardware aims to serve as high performance and low power models for deep learning. SNN has consequently evolved into Convolutional SNN (Conv-SNN). In addition, active research conducted over the past several decades has strengthened strategies for building neuromorphic hardware, including mixed analog/digital circuitry and fully digital circuitry. Fully digital neuromorphic hardware has received great attention in recent years due to its excellent scalability, reliability, and reconfigurability. Digital multicore neuromorphic processors may significantly reduce the wall clock time and power consumption of SNN computations, primarily due to asynchronous operation of the multicore and low clock frequencies.

In the case of neuromorphic hardware, Synaptic Operations (SynOPs) refers to the process of routing presynaptic (spike) to postsynaptic (destination) neurons and subsequently updating state variables (membrane potentials). This process is considered one of the key processes as it is often compared with MAC (multiply-accumulate) operation in Deep Neural Networks (DNNs). Important aspects of SynOP include (i) latency, (ii) power consumption, (iii) memory usage, and (iv) reconfigurability. In terms of (i) and (ii), SynOPs per second (SynOPS) and SynOPs and Watts per second (SynOPS/W) are considered important measurements. Aspect (iii) is of major interest because digital neuromorphic hardware uses a lot of memory and on-chip memory capacity is strictly limited. The reconfigurability of the target neuron, i.e., the network topology, must be fully supported to make the digital neuromorphic hardware versatile.

Various digital event-routing methods have been proposed to date that focus on efficiency and scalability of memory usage. However, neuron-centric event-routing is common in a variety of event-routing methods. Neuron-centric event-routing uses neurons with a granularity of connection units so that the events of the source neurons are routed to the target neurons with reference to predefined addresses using lookup tables (LUTs) ordered by crossbar or neuron address. Such methods include crossbar-based event-routing that defines connections between N presynaptic neuron and N postsynaptic neuron using an N×N memory crossbar. This method is simple and suitable for dense layers using all N and N neurons in the presynaptic and postsynaptic layers, respectively. A drawback, however, is inefficient memory usage when implementing layers with sparse connections, such as convolutional layers.

Another example of neuron-centric event-routing uses LUTs instead of memory crossbars to define connections between neurons. A simple method uses a planar LU based on pre synaptic and postsynaptic neuron addresses with no layer structure. A shallow hierarchical LUT is used in Loihi instead of a flat LUT to exploit the multicore architecture. Further, deep hierarchical LUT-based event-routing methods provide exponential scalability of synaptic connections through layers.

The aforementioned neuron-centric event-routing method fully supports the reconfigurability of the network topology at the expense of large memory usage, which strictly limits the depth of the implemented SNN given the limited capacity of the on-chip memory. In addition, weight reuse for the Conv-SNN is limited in this way, and multiple kernel weights are duplicated, which hinders efficient use of on-chip memory.

### DETAILED DESCRIPTION OF THE INVENTION

### Technical Problem

The technical problem to be solved by the present disclosure is to propose a layer-centric event-routing method based on Layer-Centric Event-routing Architecture (LaCERA) rather than a neuron-centric method. The proposed LaCERA seeks to provide reconfigurability of the Conv-SNN topology, efficient memory usage for event-routing, and extreme weight-reuse rate.

### Technical Solution

In an aspect, a method for layer-wise event-routing of spiking neural network proposed by the present disclosure includes: optimizing a data structure for performing layer-wise event-routing using a neuron address index method comprising a global index, a layer-wise index, and a neuron-group index; performing layer-wise event-routing using the LUT for each of the global index, the layer-wise index, and the neuron-group index; and compressing synaptic weight data according to a global address operation for layer-wise event-routing for neuron-group index.

The step of optimizing the data structure for performing layer-wise event-routing using the neuron address index method comprising global index, layer-wise index, and neuron-group index ensures that all neurons within the neural network have different addresses, by using the global index, according to the neuron address index used by the entire neural network unit.

The step of optimizing the data structure for performing layer-wise event-routing using the neuron address index method comprising the global index, the layer-wise index, and the neuron-group index ensures that all neurons in each layer have different addresses, by using the layer-wise index, according to the neuron address index used by each layer unit of the neural network.

The step of optimizing the data structure for performing layer-wise event-routing using the neuron address index method comprising the global index, the layer-wise index, and the neuron-group index ensures, by using the neuron-group index, that each layer is composed of multiple neuron-groups, and that all the neurons in each group have different addresses according to the neuron address index used by each neuron-group.

The step of optimizing the data structure for performing layer-wise event-routing using the neuron address index method comprising the global index, the layer-wise index, and the neuron-group index ensure that the event data packet generated by the neuron address index method comprising the global index, the layer-wise index and the neuron-group index is composed of global address of the output neuron, wherein the operation of finding the connected neuron to change the global address to the layer-wise address uses the layer-wise neuron address.

The step of performing layer-wise event-routing using the LUT for each of the global index, the layer-wise index, and the neuron-group index includes storing an address of layer and in-layer group to which the output neuron indexed by global address belongs and converting the global address of the output neuron into layer-wise neuron address, through group lookup table (Group_LUT).

The step of performing layer-wise event-routing using the LUT for each of the global index, the layer-wise index, and the neuron-group index includes storing information of each layer through layer lookup table (Layer_LUT); and storing a minimum value of a group address included in each layer, a dimension of the layer, the number of neurons included in the layer, an index of a connection type, the number of other layers connected to the layer, and information of a dimension of a layer in a case of a three-dimensional layer.

The step of performing layer-wise event-routing using the LUT for each of the global index, the layer-wise index, and the neuron-group index includes storing a hyperparameter of the kernel of the convolution layer, performing operations for determining the size of the connected layer and the address of the connected neuron in the layer, and performing synaptic weight address operation, through a connection lookup table (Connective_LUT).

The step of compressing synaptic weight data according to a global address operation for layer-wise event-routing for neuron-group index includes compressing synaptic weight data by performing the same operation for connections with identical weights during event-routing of the convolution layer to increase the weight-reuse rate.

In still another aspect, a neuromorphic processor for event-routing of spiking neural network proposed by the present disclosure includes: a neuron address indexing unit that optimizes a data structure for performing layer-wise event-routing using a neuron address index method comprising a global index, a layer-wise index, and a neuron-group index; and a routing performing unit that performs layer-wise event-routing using the LUT for each of the global index, the layer-wise index, and the neuron-group index, and compresses synaptic weight data according to a global address operation for layer-wise event-routing for neuron-group index.

### Effects of the Invention

When the memory usage efficiency of the implementation of the neural network is greatly improved through the layer-centric event-routing architecture for digital neuromorphic processors with spiking neural networks according to the embodiments of the present disclosure, the size of the neural network that may be implemented in the processor increases, and thus the emulation of the large neural network is easy. In addition, a high weight-reuse rate may be ensured in the case of the present disclosure, so that the ratio of the memory allocated to the neuron and the synapse is 5 times or less, which may greatly improve the efficiency of core memory usage in neural network mapping.

### BRIEF DESCRIPTION OF THE DRAWINGS

FIG. 1A is an example of a neuron-centric LUT, and FIG. 1B is an example of layer-centric routing LUT.

FIG. 2 is a diagram showing a comparison between LaCERA and neuron-centric routing in terms of segmentation and weight-reuse rate according to an embodiment of the present disclosure.

FIG. 3 is a diagram for illustrating in-layer neuron-index and group-wise in-layer neuron-index according to an embodiment of the present disclosure.

FIG. 4 is a flowchart for illustrating a layer-wise event-routing method of a spiking neural network according to an embodiment of the present disclosure.

FIG. 5 is a diagram showing a LaCERA pipeline algorithm according to an embodiment of the present disclosure.

FIG. 6 is a diagram showing a neuromorphic processor structure for layer-wise event-routing of a spiking neural network according to an embodiment of the present disclosure.

FIG. 7 is a diagram for illustrating a flow of converting a group-wise global neuron-index for a 3D layer into an in-layer neuron-index according to an embodiment of the present disclosure.

FIG. 8 is a diagram for illustrating memory usage for LaCERA and neurons in VGG16 with respect to neuron-group size B according to an embodiment of the present disclosure.

FIG. 9 is a timing diagram of event-routing using LaCERA according to an embodiment of the disclosure.

### BEST EMBODIMENT OF THE INVENTION

Hereinafter, embodiments of the present disclosure will be described in detail with reference to the accompanying drawings.

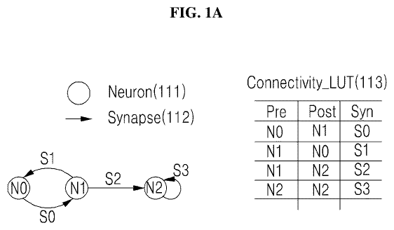

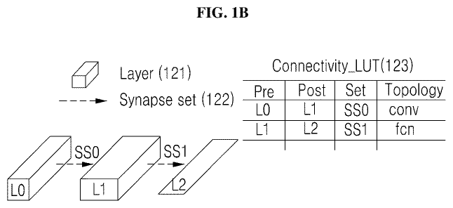

FIG. 1 is a diagram showing a connectivity lookup table for neuron-centric and layer-centric routing according to an embodiment of the present disclosure.

FIG. 1A is an example of a neuron-centric LUT, and FIG. 1B is an example of layer-centric routing LUT.

In layer-centric event-routing methods, existing approaches to phase organization use neurons as a granularity of connection units, so the crossbar or LUT defines the organization between pre-synaptic and post-synaptic neurons and synapses. An example of a configuration between a neuron 111 central LUT 113 and a synapse 112 for a toy network is shown in FIG. 1A.

A major advantage of the neuron-centric routing method is the ultimate reconfigurability of the network when using minimal segmentation. However, the ultimate reconfigurability arises due to the large memory usage for the neuron-centric LUT and synaptic weights. In particular, memory usage for synaptic weights is severe because the weight-reuse rate is very low.

Consider Cₙ×Hₙ×W, a presynaptic layer, C′ₙ×H′ₙ×W, a postsynaptic layer, C′ₙ×Cₙ×K_{H}×K_{W} a kernel. Weight-reuse rate Rᵣₑᵤₛₑ for convolution is defined as follows:

$${R}_{reuse} = \frac{Memoryforallkernels}{Actualmemoryusageforallkernels} \qquad ( 1 )$$

Since the neuron-centric event-routing method rarely supports weight reuse, the weight-reuse rate Rᵣₑᵤₛₑ for neuron-centric routing is given as follows:

$${R}_{reuse} = \frac{1}{H {}_{n}^{′} \times W {}_{n}^{′}} \qquad ( 2 )$$

In the case of Loihi, although compiler supporting weights, such as NxTF, may be used at any granularity, the reuse rate is still far below the ideal reuse rate (Rᵣₑᵤₛₑ=1).

Unlike the neuron-centric routing method, the proposed layer-centric routing methods consider layers (i.e., sub-layers called groups, to be precise) with the granularity of the network configuration, which is small enough to construct state-of-the-art SNNs of convolutional and density layers. Since both convolutional and dense layers follow certain rules for neuron-to-neuron connections between layers, the addresses of post-synaptic neurons for a given pre-synaptic nerve may be easily computed without retrieving for neuron-centric LUTs. The inter-layer connection rule depends on the layer type, which is hereinafter referred to as connection. Three types of connections (2D convolution, average pooling, and full-connection connective) are considered to construct a Conv-SNN. An example of a configuration of event-routing using the layer 121 center LUT 123 and the synapse set 122 is illustrated in FIG. 1B.

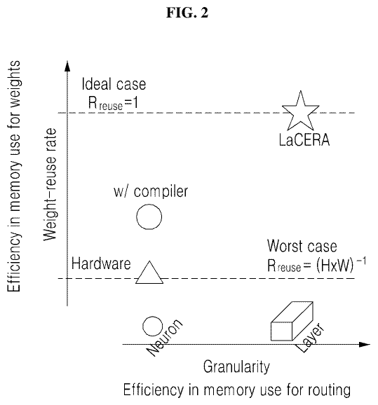

FIG. 2 is a diagram showing a comparison between LaCERA and neuron-centric routing in terms of segmentation and weight-reuse rate according to an embodiment of the present disclosure.

Referring to FIG. 2, “w/compiler” refers to the use of APIs and compilers to improve the weight-reuse rate as in NxTF.

In addition, a corresponding weight index for a specific neuron-to-neuron connection may also be calculated, which is used to retrieve a weight value from the weight memory. Therefore, convolution is performed without duplicating the kernel element, so that an ideal weight increase rate (Rᵣₑᵤₛₑ=1) may be achieved.

Hereinafter, mathematical descriptions of three connections, i.e., a full-connection connective (Fcn), a 2D convolution (Conv) of 3D feature map, and an average pooling connection (Pool), which are sufficient for constructing a Conv-SNN according to an embodiment of the present disclosure, will be described. The pre-synaptic index and post-synaptic neuron-index are denoted i and j, respectively. i and j are in-layer indexes that should be distinguished from global neuron-index. The synaptic index is denoted by m. In the present disclosure, two functions f(i) and g(i, j) are defined.

$$f ( i ) = ( min ( j ) , max ( j ) )$$

$$g ( i , j ) = m .$$

m and j represent a set of indexes. The function f(i) outputs the minimum and maximum elements of the post-synaptic neuron set j for a given pre-synaptic neuron i. The function g outputs a synaptic index set for the pre-synaptic neuron i and the post-synaptic neuron j. Since all indexes in use are non-negative integers, the data type is not specified hereafter.

A full-connection connective (Fcn) sufficient to construct a Conv-SNN according to an embodiment of the present disclosure, will be described.

The first coupling is the overall coupling for the 1D pre-synaptic and post-synaptic layers including the N and N′ neurons, respectively. For any i: j={j|0≤j<N′} is obtained. Thus, it may be represented as follows:

$${f}_{F c n} ( i ) = ( O , {N}^{′} - 1 ) \qquad ( 3 )$$

The synaptic index between the pre-synaptic neuron i and the post-synaptic neuron j may be expressed as follows.

$$m = Nj + i \qquad ( 4 )$$

Thus, it may be represented as follows:

$${g}_{F c n} ( i , j ) = \{ Nj + i \vert 0 \leq j < {N}^{′} \}$$

That is, for a given neuron i, min (j) and max (j) are determined by the dimension of the post-synaptic layer, and all indexes between the two boundaries are the indexes of the post-synaptic neuron connected to neuron i. The synaptic index m is determined by the indexes i and j according to Equation (4). Thus, the indexes of post-synaptic neurons and synapses for a given i may be obtained by calculation instead of retrieving for LUTs.

A 2D convolution (Conv) of 3D feature map according to an embodiment of the present disclosure, will be described.

The present disclosure deals with 2D convolution of 3D pre-synaptic layer (feature map) using rank-3 kernel. Consider Cₙ×Hₙ×W, a pre-synaptic layer, C′ₙ×H′ₙ×W, a post-synaptic layer, C′ₙ a kernel. In the present disclosure, all kernels are considered as a sum of rank-4 tensor C′ₙ×Cₙ×K_{H}×K_{W}. The pre-synaptic is convolved using a Cₙ×K_{H}×K_{W} kernel with stride of s_{H} and s_{w} along the H-axis and W-axis, respectively. Additionally, offsets, Oₕ and O_{W}, which are commonly used in zero-padding, are considered. Thus, the size of the post-synaptic layer is given as follows:

$$\{ \begin{matrix}C {}_{n}^{′} \\ H {}_{n}^{′} = ⌊ s {}_{H}^{- 1} ( {H}_{n} + 2 {o}_{H} - {K}_{H} ) ⌋ + 1 \\ W {}_{n}^{′} = ⌊ s {}_{W}^{- 1} ( {W}_{n} + 2 {o}_{H} - {K}_{W} ) ⌋ + 1\end{matrix} \qquad ( 5 )$$

In the present disclosure, 3D coordinates are used to indicate the positions of the pre-synaptic neurons I(i_{C}, i_{H}, i_{W}) and the post-synaptic neurons J(j_{C}, j_{H}, j_{W}). The synaptic elements of the rank-4 kernel are denoted by (m_{K}, m_{C}, m_{H}, m_{W}) and may be converted into one-dimensional synaptic indexes as follows:

$$m = {C}_{n} {K}_{H} {K}_{W} {m}_{K} + {K}_{H} {K}_{W} {m}_{C} + {K}_{W} {m}_{H} + {m}_{W} . \qquad ( 6 )$$

The post-synaptic neurons J(j_{C}, j_{H}, j_{W}) is connected to the pre-synaptic neurons I (i_{C}, i_{H}, i_{W}) to satisfy:

$$\{ \begin{matrix}0 \leq {i}_{C} \leq {C}_{n} \\ max ( {s}_{H} {j}_{H} - {o}_{H ,} 0 ) \leq {i}_{H} \leq ( {s}_{H} {j}_{H} + {K}_{H} {-}_{{{O}_{H ,}}^{}} {H}_{n} ) \\ max ( {s}_{W} {j}_{W} - {o}_{W ,} 0 ) \leq {i}_{W} \leq ( {s}_{W} {j}_{W} + {K}_{W} - {o}_{W ,} {W}_{n} )\end{matrix} \qquad ( 7 )$$

Equation (7) gives the range of post-synaptic neuron-indexes (j_{C}, j_{H}, j_{W}) connected to a given pre-synaptic neurons I(i_{C}, i_{H}, i_{W}):

$$\{ \begin{matrix}0 \leq {j}_{C} \leq C {}_{n}^{′} \\ j {}_{H}^{min} \leq {j}_{H} \leq j {}_{H}^{max} \\ j {}_{W}^{min} \leq {j}_{W} \leq j {}_{W}^{max}\end{matrix} \qquad ( 8 )$$

$$wherein :$$

$${j}_{H}^{min} = max ( ⌊ S {}_{H}^{- 1} ( {i}_{H} + {o}_{H} - {K}_{H} ) + 1 ⌋ , 0 )$$

$${j}_{H}^{max} = min ( ⌊ S {}_{H}^{- 1} ( {i}_{H} + {o}_{H} + 1 ) ⌋ , H {}_{n}^{′} )$$

$${j}_{W}^{min} = max ( ⌊ {S}_{W}^{- 1} ( {i}_{W} + {o}_{W} - {K}_{W} ) + 1 ⌋ , 0 )$$

$${j}_{W}^{max} = min ( ⌊ {S}_{W}^{- 1} ( {i}_{W} + {o}_{W} + 1 ) ⌋ , W {}_{n}^{′} )$$

The corresponding synaptic index for a given mₖ is given as follows:

$$\{ \begin{matrix}{m}_{C} = {i}_{C} \\ {m}_{H} = {i}_{H} + {o}_{H} - {s}_{H} {j}_{H} \\ {m}_{W} = {i}_{W} + {o}_{W} - {s}_{W} {j}_{W}\end{matrix}$$

Using the Equation (6), for all my in the range 0≤mₖ≤C′ₖ,

$$m = {C}_{{nK}_{H}} {K}_{W} {m}_{K} + {K}_{H} {K}_{W} {i}_{C} + {K}_{W} ( {i}_{H} + {o}_{H} - {s}_{H} {j}_{H} ) + ( {i}_{W} + {o}_{W} - {s}_{W} {j}_{W} ) . \qquad ( 9 )$$

An average pooling pool according to an embodiment of the disclosure, will be described.

The average pooling of the 3D pre-synaptic layer may be considered as a 2D convolution of the channel layer, which contains events of (iC, iH, iW), using a rank-2 kernel wₚₒₒₗ∈^{k}^{ₙ}^{×k}^{_{w}}′:

$$∀ {m}_{H} and {m}_{W} , {W}_{pool} [ {m}_{H} , {m}_{W} ] = 1 / ( {K}_{H} {K}_{W} ) . \qquad ( 10 )$$

The strides s_{H} and s_{W} are set to K_{H} and K_{W}, respectively. Thus, the dimension of the pooling layer C′ₙ×H′ₙ×W′, is given as follows:

$$\{ \begin{matrix}C {}_{n}^{′} = {C}_{n} \\ H {}_{n}^{′} = ⌊ s {}_{H}^{- 1} {H}_{n} - 1 ⌋ + 1 \\ W {}_{n}^{′} = ⌊ s {}_{W}^{- 1} {W}_{n} - 1 ⌋ + 1\end{matrix}$$

Similar to Equation (8), the range of post-synaptic neuron-indexes (j_{C}, j_{H}, j_{W}) in the pooling layer may be expressed as follows:

$$\{ \begin{matrix}{j}_{C} = {i}_{C} \\ max ( {s}_{H}^{- 1} {i}_{H} , O ) \leq {j}_{H} \leq ( {s}_{H}^{- 1} {i}_{H} + 1 , H {}_{n}^{′} ) \\ max ( {s}_{W}^{- 1} {i}_{W} , O ) \leq {j}_{W} \leq ( s {}_{W}^{- 1} {i}_{W} + 1 , W {}_{n}^{′} )\end{matrix} \qquad ( 11 )$$

For this connection, there is no need to calculate the corresponding synaptic index since all connective are given the same weight 1/(K_{H}K_{W}).

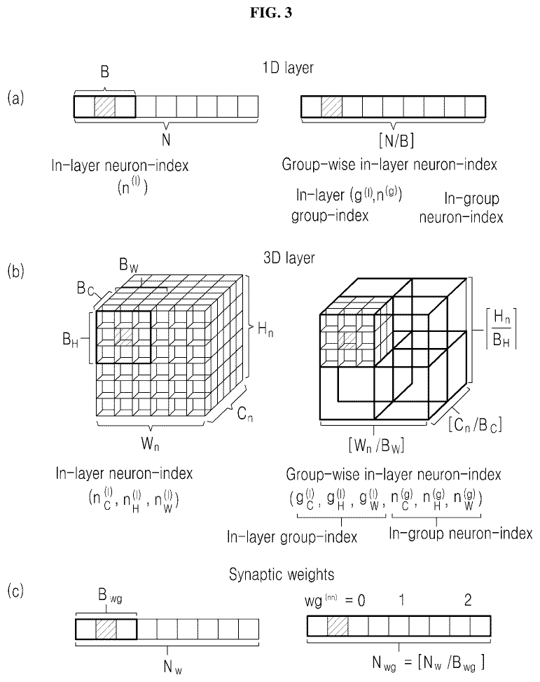

FIG. 3 is a diagram for illustrating in-layer neuron-index and group-wise in-layer neuron-index according to an embodiment of the present disclosure.

FIG. 3A shows a 1D layer, FIG. 3B shows a 3D layer, and FIG. 3C shows an in-layer neuron-index and group-wise in-layer neuron-index of an arrangement of N_{w} weight and N_{wg} weight groups. Here, the size of each weight group is B_{wg}.

Neurons in a given layer according to embodiments of the disclosure are indexed using the in-layer indexes i and (i_{C}, i_{H}, i_{W}) for the 1D layer and the 3D layer, respectively. In the present disclosure, the layer is divided into in-layer indexed sub-layer (sizes B and B_{C}×B_{H}×B_{W} for 1D and 3D layers, respectively) (FIG. 3). In the present disclosure, such sub-layer is called a group. Thus, each neuron may be indexed using the index and in-group index of the host group. The following uses exponential notation

$${x}_{y}^{( z )}$$

for the 3D layer:
x is an indexed object. x∈{n,g}, wherein n and g represent neuron and group, respectively.
y is the basis of the index. y∈{C,H,W}, wherein C, H, W represent channel axis, height axis, width axis, respectively.
z is an exponential domain. z∈{nn,l,g}, wherein nn, l, and g represent the entire network, layer, group, respectively.

For example,

$$n {}_{C}^{( nn )} , n {}_{H}^{( l )} , n {}_{W}^{( g )}$$

represents the global neuron-index along the channel axis, the in-layer neuron-index along the height axis, and the in-group neuron-index along the width axis, respectively. For the 1D layer, we do not specify index-based (subscripts) such as

$$n {}_{C}^{( nn )} , n {}_{H}^{( l )} , n {}_{W}^{( g )} .$$

According to a new notation according to an embodiment of the disclosure, the in-layer index i is rewritten by n^{(l)}. Given the size of each group B, the in-layer index of group g^{(l)} is arranged as follows:

$$0 \leq {g}^{( l )} < ⌈ N / B ⌉ ,$$

wherein N is the number of neurons in the 1D layer. The value [N/B] is the number of groups belonging to the 1D layer. The range of the in-group neuron-index n^{(g)} for a group with size B is O≤n^{(g)}<E. Accordingly, the in-layer neuron-index n^{(l)} may be converted into group-wise in-layer neuron-index (g^{(l)}, n^{(g)}), as shown in FIG. 3A, satisfying the following:

$${n}^{( l )} = B {g}^{( l )} + {n}^{( g )} \qquad ( 12 )$$

The in-layer indexes (i_{C}, i_{H}, i_{W}) according to embodiments of the present disclosure are rewritten as

$$( {n}_{C}^{( l ) ,} {n}_{H}^{( l )} , {n}_{W}^{( l )} ) .$$

Considering the size of each group (B_{C}×B_{H}×B_{W}), the group in-layer index

$$( {g}_{C}^{( l 〉 ,} {g}_{H}^{( l )} , {g}_{W}^{( l )} )$$

falls within the following ranges:

$$\{ \begin{matrix}0 \leq g {}_{C}^{( l )} < {C}_{g} = ⌈ {C}_{n} / {B}_{C} ⌉ \\ 0 \leq g {}_{H}^{( l )} < {H}_{g} = ⌈ {H}_{n} / {B}_{H} ⌉ \\ 0 \leq g {}_{W}^{( l )} < {W}_{g} = ⌈ {W}_{n} / {B}_{W} ⌉\end{matrix}$$

wherein C_{g}, H_{g}, W_{g} are the total number of groups in a given 3D layer along the channel axis, height axis, width axis, respectively. The values ┌Cₙ/B_{C}┐, ┌Hₙ/B_{H}┐, ┌Wₙ/B_{W}┐ are the number of groups belonging to the 3D layer. Considering the size of the group (B_{C}×B_{H}×B_{W}), range of the in-group neuron-index

$$( {g}_{C}^{( l ) ,} {g}_{H}^{( l )} , {g}_{W}^{( l )} )$$

is as follows:

$$\{ \begin{matrix}0 \leq n {}_{C}^{( g )} < {B}_{C} \\ 0 \leq n {}_{H}^{( g )} < {B}_{H} \\ 0 \leq n {}_{W}^{( g )} < {B}_{W}\end{matrix}$$

Therefore, the in-layer neuron-index

$$( {n}_{C}^{( l ) ,} {n}_{H}^{( l )} , {n}_{W}^{( l )} )$$

may be converted into the group-wise in-layer neuron-index

$$( {g}_{C}^{( l ) ,} {g}_{H}^{( l )} , {g}_{W}^{( l )} , n {}_{C}^{( g ) ,} n {}_{H}^{( g )} , {n}_{W}^{( g )} ) ,$$

as shown in FIG. 3B, satisfying the following:

$$\{ \begin{matrix}n {}_{C}^{( l )} = {B}_{C} g {}_{C}^{( l )} + n {}_{C}^{( g )} \\ n {}_{H}^{( l )} = {B}_{H} g {}_{H}^{( l )} + n {}_{H}^{( g )} \\ n {}_{W}^{( l )} = {B}_{W} g {}_{W}^{( l )} + n {}_{W}^{( g )}\end{matrix} \qquad ( 13 )$$

According to an embodiment of the present disclosure, synapses are also grouped for neurons in the 1D layer. Weighted index notation x^{(z)} is used according to the neuron-index notation.
x is an indexed object. x∈{m, wg}, wherein m and wg represent weights and weights groups, respectively.
z is an exponential domain. z∈{nn, c}, wherein nn and c represent the entire network and connective, respectively.

For example, m^{(c)} and m⁽ⁿⁿ⁾ are the weight indexes in a given connective c and global weight index, respectively.

As shown in FIG. 3C, the total N_{w} weights in the network are divided into N_{wg} groups, each of size B_{wg}. The weight index function g in Equations (4) and (9) outputs the in-connective index m^{(c)} of the weights, which should be converted into the corresponding global index m⁽ⁿⁿ⁾. The conversion is performed using the following equation:

$${m}^{( nn )} = {B}_{w g} {wg}^{( nn )} + {m}^{( c )} \qquad ( 14 )$$

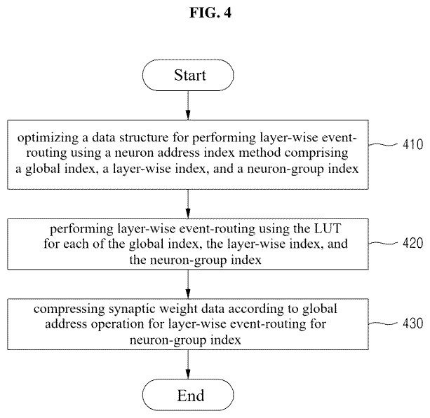

FIG. 4 is a flowchart for illustrating a layer-wise event-routing method of a spiking neural network according to an embodiment of the present disclosure.

The proposed layer-wise event-routing method for spiking neural network includes: optimizing 410 a data structure for performing layer-wise event-routing using a neuron address index method comprising a global index, a layer-wise index, and a neuron-group index, a layer-wise index, and a neuron-group index; performing 420 layer-wise event-routing using the LUT for each of the global index, the layer-wise index, and the neuron-group index; and compressing 430 synaptic weight data according to a global address operation for layer-wise event-routing for neuron-group index.

In step 410, the neuron address index method comprising global index, layer-wise index, and neuron-group index is used to optimize the data structure for performing layer-wise event-routing.

The global index according to an embodiment of the present disclosure is used to ensure that all neurons within the neural network have different addresses according to the neuron address index used by the entire neural network unit.

The layer-wise index according to an embodiment of the present disclosure is used to ensure that all neurons in each layer have different addresses according to the neuron address index used by each layer unit of the neural network.

The neuron-group index according to the embodiment of the disclosure is used to ensure that each layer is composed of multiple neuron-groups, and that all the neurons in each group have different addresses according to the neuron address index used by each neuron-group.

According to an embodiment of the present disclosure, the event data packet generated by using the neuron address index method comprising the global index, the layer-wise index and the neuron-group index is composed of global address of the output neuron, and the operation of finding the connected neuron to change the global address to the layer-wise address uses the layer-wise neuron address.

In step 420, the layer-wise event-routing is performed using the LUT for each of the global index, the layer-wise index, and the neuron-group index.

Through group lookup table (Group_LUT) according to an embodiment of the present disclosure, the address of layer and in-layer group are stored to which the output neuron indexed by global address belongs, and the global address of the output neuron is converted into layer-wise neuron address.

Through layer lookup table (Layer_LUT) according to an embodiment of the present disclosure, information of each layer is stored, and the minimum value of a group address is stored, included in each layer, a dimension of the layer, the number of neurons included in the layer, an index of a connection type, the number of other layers connected to the layer, and information of a dimension of a layer in a case of a three-dimensional layer.

Through connection lookup table (Connective_LUT) according to an embodiment of the present disclosure, the hyperparameter of the kernel of the convolution layer is stored, operations for determining the size of the connected layer and the address of the connected neuron in the layer are perform, and synaptic weight address operation is performed.

In step 430, the synaptic weight data is compressed according to a global address operation for layer-wise event-routing for neuron-group index.

According to an embodiment of the disclosure, the synaptic weight data is compressed by performing the same operation for connections with identical weights during event-routing of the convolution layer, in order to increase the weight reuse rate.

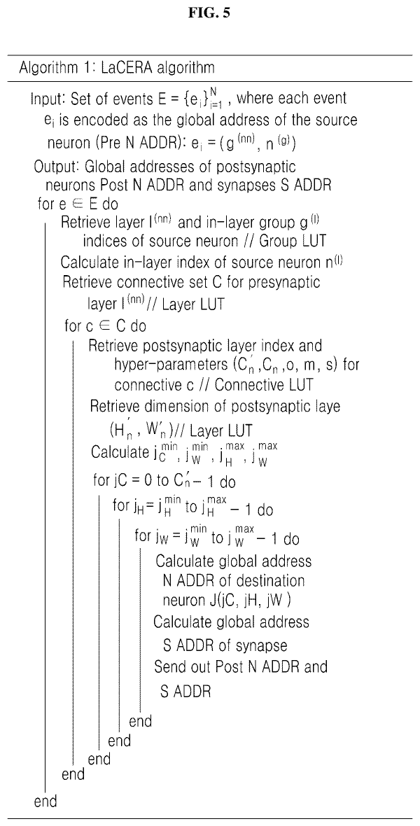

FIG. 5 is a diagram showing a LaCERA pipeline algorithm according to an embodiment of the present disclosure.

According to an embodiment of the present disclosure, LaCERA was implemented on a Xilinx Virtex-7 FPGA, referred to as the LaCERA block, based on three basic connection devices (Fcn, Conv, Pool). The LaCERA block receives the global address n⁽ⁿⁿ⁾ of the event source neuron Pre N ADDR and outputs the global addresses of the post-synaptic (target) neuron Post N ADDR and the fan-out synapse S ADDR. It is noted that in the present disclosure, N_ADDR is generally used without a prefix to represent the global address of a neuron. The LaCERA pipeline is described in Algorithm 1.

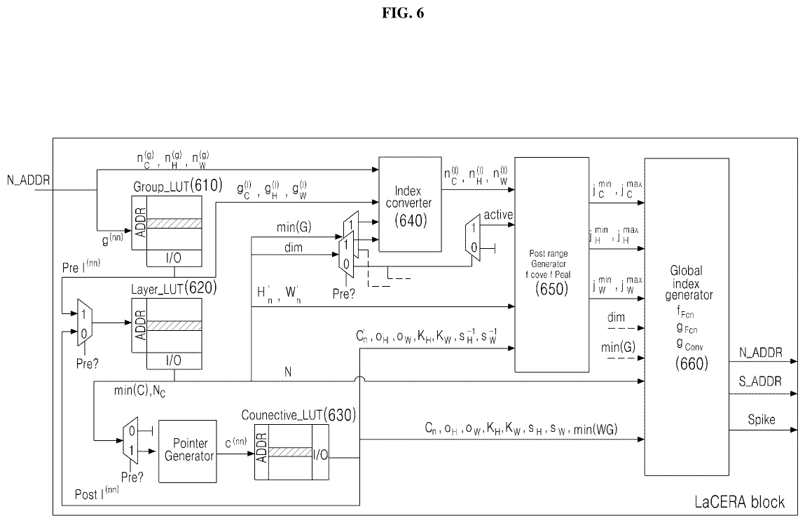

FIG. 6 is a diagram showing a neuromorphic processor structure for layer-wise event-routing of a spiking neural network according to an embodiment of the present disclosure.

A neuromorphic processor for layer-wise event-routing of spiking neural network according to an embodiment of the present disclosure includes: a neuron address indexing unit that optimizes a data structure for performing layer-wise event-routing using a neuron address index method comprising a global index, a layer-wise index, and a neuron-group index; and a routing performing unit that performs layer-wise event-routing using the LUT for each of the global index, the layer-wise index, and the neuron-group index, and compresses synaptic weight data according to a global address operation for layer-wise event-routing for neuron-group index.

The neuron address indexing unit according to an embodiment of the present disclosure ensures: that all neurons within the neural network have different addresses, by using the global index, according to the neuron address index used by the entire neural network unit; that all neurons in each layer have different addresses, by using the layer-wise index, according to the neuron address index used by each layer unit of the neural network; and by using the neuron-group index, that each layer is composed of multiple neuron-groups, and that all the neurons in each group have different addresses according to the neuron address index used by each neuron-group.

The routing performing unit according to an embodiment of the present disclosure includes group lookup table (Group_LUT), layer lookup table (Layer_LUT), and connection lookup table (Connective_LUT).

Through group lookup table (Group_LUT) according to an embodiment of the present disclosure, the address of layer and in-layer group are stored to which the output neuron indexed by global address belongs; and the global address of the output neuron is converted into layer-wise neuron address.

Through layer lookup table (Layer_LUT) according to an embodiment of the present disclosure, information of each layer is stored, and the minimum value of a group address is stored, included in each layer, a dimension of the layer, the number of neurons included in the layer, an index of a connection type, the number of other layers connected to the layer, and information of a dimension of a layer in a case of a three-dimensional layer.

Through connection lookup table (Connective_LUT) according to an embodiment of the present disclosure, the hyperparameter of the kernel of the convolution layer is stored, operations for determining the size of the connected layer and the address of the connected neuron in the layer are perform, and synaptic weight address operation is performed.

Through connection lookup table (Connective_LUT) according to an embodiment of the disclosure, the synaptic weight data is compressed by performing the same operation for connections with identical weights during event-routing of the convolution layer, in order to increase the weight reuse rate.

*133 The layer-centric event-routing architecture for digital neuromorphic processors with spiking neural networks according to an embodiment of the present disclosure will be described in more detail with reference to FIG. 6.

The LaCERA block receives the global address of the source neuron to retrieve the global address of a post-synaptic neuron and a fan-out synapse. The global address of the source neuron must be converted to the in-layer index to calculate the range of in-layer indexes of the post-synaptic neuron. This is performed in the index converter 640 of FIG. 6 using Equations (12) and (13) for the 1D layer and the 3D layer, respectively. In the present disclosure, the group size (B and B_{C}×B_{H}×B_{W} for 1D and 3D layers, respectively) is kept constant across the entire layer of a given network.

In the present disclosure, the 1D group size is set to B=B_{C}×B_{H}×B_{W} so that the same bit width is allocated to the each in-group neuron-index of the 1D layer as in the 3D layer. Further, the group in the three-dimensional layer is a cube, that is, B_{C}=B_{H}=B_{W}=B^{1/3}. Thus, the global address of the neurons of the network N_ADDR is of the same data format, ignoring the indexes and dimensions of the host layer.

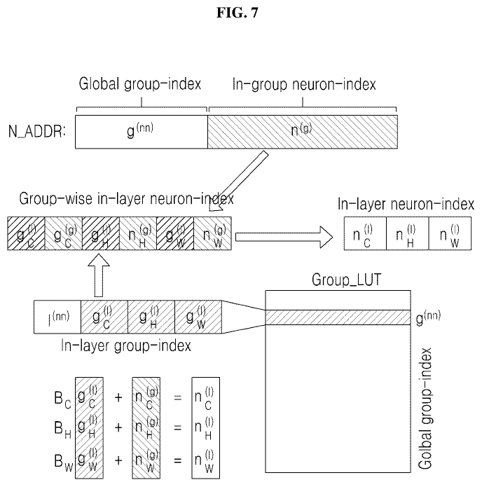

FIG. 7 is a diagram for illustrating a flow of converting a group-wise global neuron-index for a 3D layer into an in-layer neuron-index according to an embodiment of the present disclosure. As shown in FIG. 7, N_ADDR is a group-wise global neuron-index composed of the global index of the host group g⁽ⁿⁿ⁾ and the in-group index of the neuron n(g). Considering, BC=BH=BW=B^{1/3}, the 3D in-group neuron-index (n_{C}^{(g)}, n_{H}^{(g)}, n_{W}^{(g)}), is obtained from the 1D in-group index n^{(g)}.

$$\{ \begin{matrix}{n}_{C}^{( g )} = {n}^{( g )} [ 2 / 3 {log}_{2} B : {log}_{2} B - 1 ] \\ {n}_{H}^{( g )} = {n}^{( g )} [ 1 / 3 {log}_{2} B : 2 / 3 {log}_{2} B - 1 ] \\ {n}_{W}^{( g )} = {n}^{( g )} [ 0 : 1 / 3 {log}_{2} B - 1 ]\end{matrix} \qquad ( 15 )$$

As shown in FIG. 7, the in-group neuron-index

$$( {n}_{C}^{( g )} , {n}_{H}^{( g )} , {n}_{W}^{( g )} )$$

may be easily obtained from N_ADDR using Equation (15). Further required data are host group of in-layer index

$$( {g}_{C}^{( l )} , {g}_{H}^{( l )} , {g}_{W}^{( l )} ) ,$$

which may use the global group index g⁽ⁿⁿ⁾ in N_ADDR. The global group index g⁽ⁿⁿ⁾ is converted into the in-layer group index

$$( {g}_{C}^{( l )} , {g}_{H}^{( l )} , {g}_{W}^{( l )} )$$

using LUT that stores the in-layer group indexes of a given global group index. Such LUT is referred to as a Group_LUT 610 as in FIG. 6.

Referring back to FIG. 6, Post range Generatlr 650 calculates the range of the in-layer index of the post-synaptic neuron relative to the in-layer index source neuron using Equations (8) and (11) to implement f_{Conv} and f_{Pool} functions. For the Fcn connective, the f_{Fcn} function is implemented in a Global index generator 660. That synaptic index is calculated using Equations (4) and (9) for the Fen and Conv connective, respectively, which are executed in the global index generator of FIG. 6. The synaptic index for Pool connective does not need to be calculated, since all connectives are assigned the same weight 1/(K_{H}K_{W}).

The post-synaptic neuron-index output from post range generatlr 650 should be inverse converted to the global index N_ADDR using the group-wise global index run in global index generator 660 of FIG. 6. To begin, the present disclosure defines a set of group indexes belonging to layer l (G^{(l)}) as follows:

$${G}^{( l )} = \{ a , a + 1 , … , a + b - 1 \}$$

wherein a is the cumulative number of groups up to layer 1-1,

$$a = {\sum }_{i}^{l - 1} \vert {G}^{( i )} \vert ,$$

and b is the number of groups belonging to layer l. The 1D in-layer neuron-index n^{(l)} is inversely converted to the global neuron-index as follows:

$$N\_ADDR = {n}^{( l )} + B min ( {G}^{( l )} ) \qquad ( 16 )$$

wherein min (G^{(l)}) is the minimum element of the set G^{(l)}. This value is stored in the Later_LUT 620 and retrieved with reference to the layer index l⁽ⁿⁿ⁾. The 3D in-layer neuron-index

$$( {n}_{C}^{( l )} , {n}_{H}^{( l )} , {n}_{W}^{( l )} )$$

is inversely converted to the global neuron-index (N_ADDR) using the following equation:

$$N\_ADDR {=}^{Bmin ( {G}^{( l )} ) + B ( {H}_{G} {W}_{G} {g}_{C}^{( l )} + {W}_{g} {g}_{H}^{( l )} + {g}_{W}^{( l )} ) + {B}^{2 / 3} {n}_{C}^{( g )} + {B}^{1 / 3} {n}_{H}^{( g )} + {n}_{W}^{( g )}} \qquad ( 17 )$$

$$wherein$$

$${g}_{( . )}^{( l )} and {n}_{( . )}^{( g )} ,$$

(·)∈{C,H,W} are easily obtained from the in-layer indexes as in FIG. 7.

The weight index function g generates an in-connective weight index m^{(c)} as in Equations (4) and (9). If the total weight is arranged in a single memory of the proposed architecture, it is processed with reference to the global index m⁽ⁿⁿ⁾. Therefore, in the present disclosure, the in-connective index m^{(c)} should be converted into the global weight index m⁽ⁿⁿ⁾. The set of group indexes belonging to connective c(WG^{(c)}) is defined as follows:

$${WG}^{( c )} = \{ a , a + 1 , … , a + b - 1 \}$$

wherein a is the cumulative number of weights up to connective c-1,

$$a = {\sum }_{i}^{C - 1} \vert {WG}^{( i )} \vert ,$$

and b is the number of weights belonging to the connective c. The conversion is performed using the following equation:

$${m}^{{( n n )}_{=}} {n}^{( c )} + {B}_{w g} min ( W {G}^{( c )} )$$

wherein B_{wg} represents the size of each weight group as shown in FIG. 3C. The minimum value WG^{(c)} is stored in the Connective_LUT 630, and this value is retrieved with reference to the connective index. The conversion is performed in the global index generator 660 of FIG. 6.

The LaCERA according to the embodiment of the disclosure uses three LUTs: Group_LUT 610, Layer_LUT 620, and Connective_LUT 630. Group_LUT 610 stores (i) the in-layer group index

$$( {g}_{C}^{( l )} , {g}_{H}^{( l )} , {g}_{W}^{( l )} )$$

and (ii) the global layer index l⁽ⁿⁿ⁾ for a given 3D layer. The Group_LUT 610 is processed with reference to the group index g⁽ⁿⁿ⁾ for the event source neuron. For events from the 3D pre-synaptic layer, in-layer neuron-indexes

$$( {n}_{C}^{( l )} , {n}_{H}^{( l )} , {n}_{W}^{( l )} )$$

are calculate using the data (i) and the in-group neuron-indexes

$$( {n}_{C}^{( g )} , {n}_{H}^{( g )} , {n}_{W}^{( g )} ) )$$

of N_ADDR. In addition, the data (ii) for the pre-synaptic layer is read to be used as a pointer of the Layer_LUT 620 for retrieving the number and minimum index of connectives for the pre-synaptic layer. Group_LUT 610 therefore uses memory by M_{Group}.

$${M}_{Group} = \frac{{N}_{tot}}{B} ( ⌈ {log}_{2} max ( {C}_{g} {H}_{g} {W}_{g} ) ⌉ + ⌈ {log}_{2} {L}_{tot} , ⌉ ) \qquad ( 18 )$$

wherein Ntot and Ltot respectively refer to the total number of neurons and layers in the entire network. The value of max (CgHgWg) is the number of groups of the largest layer in the specified SNN.

Layer_LUT 620 stores (i) the minimum element of the set of global group index g⁽ⁿⁿ⁾ belonging to a given layer (min(G^{(l)})), (ii) the layer dimension (dimension=1D or 3D), (iii) the number of in-layer neurons, (iv) the minimum connective index (min (C^{(l)})), and (v) the number of connectives Nc, (vi) the in-layer neuron configuration (Hn, Wn) for the given layer. Cn may be used in the Connective_LUT 630. This data is processed with reference to the layer index l⁽ⁿⁿ⁾. The data (i) is used for the inverse inversion of Equations (16) and (17). The data (ii) represents the size of the pre-synaptic layer to determine whether to use Equation (16) or Equation (17) to convert the global group-wise global neuron-index into the in-layer neuron-index. For Fon connective, the function f_{Fcn} and the synaptic weight index m are calculated in Equations (3) and (4), respectively, using data (iii).

The data (iv) and (v) of Layer_LUT 620 generate pointers to process Connective_LUT 630 to retrieve data for calculation of post-synaptic layer index, post-synaptic neuron-index, weight index. The data (vi) is read with reference to the post-synaptic layer index of the Connective_LUT 630, and the post-synaptic neuron-index upper limit of Equation (8) for the 3D post-synaptic layers is calculated. In addition, the data (vi) is used to inverse conversion the 3D in-layer index of post-synaptic neurons into a group-wise global index using Equation (17). For the inverse conversion of the 1D in-layer index of the post-synaptic neuron, the conversion is based on Equation (16) using data (i). Overall, Layer_LUT 620 uses memory by M_{Layer}.

$${M}_{layer} = {L}_{tot} ⌈ {log}_{2} {N}_{tot} / B ⌉ + 1 + ⌈ {log}_{2} max ( N ) ⌉ + ⌈ {log}_{2} {C}_{tot} , ⌉ + ⌈ {log}_{2} max ( {N}_{c} ) ⌉ + ⌈ {log}_{2} max ( {H}_{n} {W}_{n} ) ⌉ ) \qquad ( 19 )$$

wherein max(N), Cₜₒₜ, max(N_{c}), max(HₙWₙ) represent the maximum number of neurons in a layer, the total number of connections in a given network, the maximum number of connections of a single layer, the maximum product HnWn of a single layer, respectively.

The Connective_LUT 630 stores (i) a post-synaptic layer index, (ii) a minimum element of a global weight group index set belonging to a given connective (min(WG^{(c)})), (iii) a connective type (Conv or Pool) for the 3D post-synaptic layers, and (iv) a rank-4 kernel for the Conv or Pool connective

$$( {C}_{n}^{′} , {C}_{n} , {K}_{H} , {K}_{W} , {o}_{H} , {o}_{W} , {s}_{H} , {s}_{W} , {s}_{H}^{- 1} , {s}_{W}^{- 1} ) .$$

However, the data (iii) and (iv) are not needed connective for Fcn connective. The data of the Connective_LUT 630 is processed with reference to the connective index c⁽ⁿⁿ⁾. The data (i) is used to retrieve data of the post-synaptic layer in the LUT as described above. The global weight index for a given connective is calculated using Equation (4.4) with data (ii). The Fen connective is applied to the 1D post-synaptic layer, while the Conv or Pool connective is applied to 3D post-synaptic layer. In this regard, data (iii) specifies the connective type (Conv or Pool) for a given 3D post-synapse layer. The data (iv) computes the in-layer index of the post-synaptic neuron and the in-connective weight index for the Conv connective using Equations (8) and (9), and the in-layer index for the Pool connective using Equations (10) and (11). Overall, the Connective_LUT 630 uses MCon's memory.

$${M}_{C o n} = {C}_{tot} ( ⌈ {log}_{2} {L}_{tot} ⌉ + ⌈ {log}_{2} W {G}_{tot} ⌉ + {M}_{0} )$$

wherein WGtot represents the total number of weight groups of the entire network. M₀ is a memory for data (iii) and (iv) that does not scale with network size.

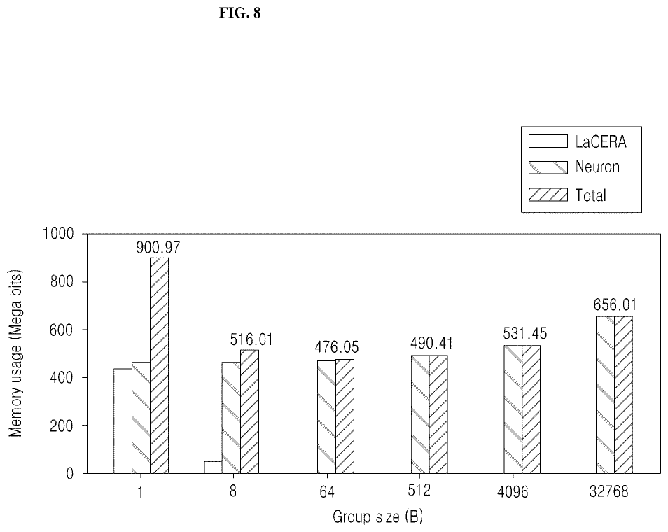

FIG. 8 is a diagram for illustrating memory usage for LaCERA and neurons in VGG16 with respect to neuron-group size B according to an embodiment of the present disclosure.

Memory usage decreases with neuron-group size B because MGroup and MLayer decrease with B according to Equations (18) and (19). Larger groups are therefore preferred. However, the larger the neuron-group size B, the more unused neurons are introduced into the neuron-group, resulting in increased memory usage for a particular layer. For example, FIG. 8 shows LaCERA and neuron-only memory in VGG16 for group size B. In this regard, the present disclosure selects the neuron-group size B of 64 as the optimal size for the next task. In addition, the weight group size B_{wg} was set to 64.

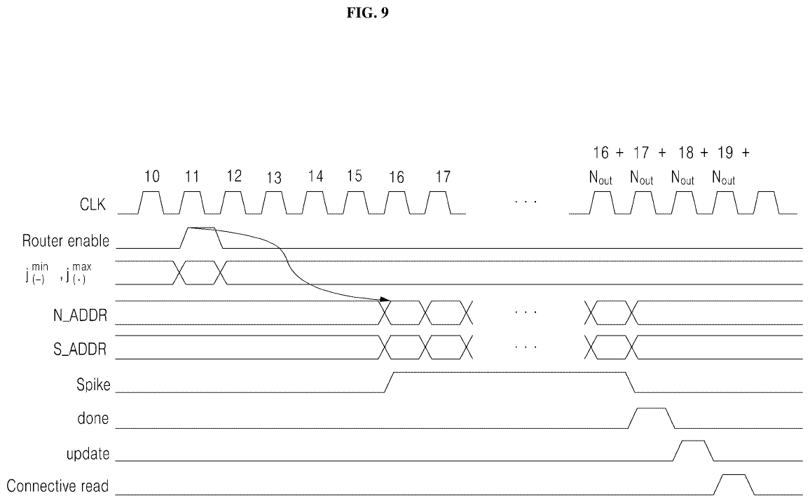

FIG. 9 is a timing diagram of event-routing using LaCERA according to an embodiment of the disclosure.

Nₒᵤₜ represents the number of postsynaptic neurons for a given presynaptic neuron. Nₛₑₜ represents the number of connections in the presynaptic layer.

The event-routing latency for LaCERA may be seen in the timing diagram of FIG. 9. As shown in the LaCERA pipeline of the algorithm of FIG. 5, since all post-synaptic neuron-indexes across multiple layers are output in a serial fashion, the routing latency for a single event scales with the post-synaptic neuron-indexes as follows.

$${T}_{r o u t e} = [ {N}_{s e t} ( {N}_{o u t} + 13 ) + 3 ] / {f}_{clk}$$

wherein Nₛₑₜ, Nₒᵤₜ, f_{clk} represent the number and clock frequency of post-synaptic neurons and the post-synaptic layer for a given source neuron, respectively. The event input event throughput per second (EPS) is the reciprocal of the event-routing latency

$$( {T}_{route}^{- 1} ) ,$$

and is inversely proportional to Nₛₑₜ and Nₒᵤₜ. The maximum input event throughput achieves 5.88 MEPS when Nₛₑₜ=Nₒᵤₜ=1.

The device described above may be implemented in hardware components, software components, and/or a combination of hardware components and software components. For example, the devices and components described in the embodiments may be implemented using one or more general-purpose or special-purpose computers, such as, for example, processor, controller, arithmetic logic unit (ALU), digital signal processor, microcomputer, field programmable array (FPA), programmable logic unit (PLU), microprocessor, or any other device capable of executing and responding to instructions. The processing device may execute an operating system (OS) and one or more software applications executed on the operating system. Further, the processing device may also access, store, manipulate, process, and generate data in response to execution of the software. For ease of understanding, it may be described that one processing device is used, but a person skilled in the art may know that the processing device may include a plurality of processing elements and/or a plurality of types of processing elements. For example, the processing device may include a plurality of processors or one processor and one controller. Other processing configuration, such as parallel processor, are also possible.

The software may include a computer program, code, instruction, or a combination of one or more of these, and may configure the processing device to operate as desired or may instruct the processing device independently or collectively. Software and/or data may be embodied in any type of machine, component, physical device, virtual equipment, computer storage medium, or device for interpretation by, or provision of instructions or data to, a processing device. The software may be distributed on a networked computer system, stored or executed in a distributed manner. The software and data may be stored in one or more computer readable recording media.

The method according to the embodiments may be embodied in the form of program instructions executable by various computer means and recorded on a computer readable medium. The computer-readable medium may include program instructions, data files, data structures, and the like, alone or in combination. The program instructions recorded on the medium may be those specially designed and configured for the embodiments or those known and usable by those skilled in the art of computer software. Examples of the computer-readable recording medium include magnetic media such as a hard disk, a floppy disk, and a magnetic tape, optical media such as a CD-ROM and a DVD, magneto-optical media such as a floptical disk, and hardware devices specially configured to store and perform program instructions such as a ROM, a RAM, and a flash memory. Examples of the program instructions include machine language codes such as those made by a compiler, as well as high-level language codes that may be executed by a computer using an interpreter or the like.

Although the embodiments have been described above with reference to the limited embodiments and the drawings, those skilled in the art may make various modifications and variations from the above description. For example, suitable results may be achieved if the described techniques are performed in an order different from that described, and/or if components of the described systems, structures, devices, circuits, etc., are combined or brought together in a form different from that described or are substituted or substituted for by other components or equivalents.

Therefore, other implementations, other embodiments, and equivalents of the claims are also within the scope of the following claims.

1. An event-routing method for spiking neural network, comprising:
optimizing a data structure for performing layer-wise event-routing using a neuron address index method comprising a global index, a layer-wise index, and a neuron-group index;
performing layer-wise event-routing using the LUT for each of the global index, the layer-wise index, and the neuron-group index; and
compressing synaptic weight data according to a global address operation for layer-wise event-routing for neuron-group index.

2. The event-routing method for spiking neural network of claim 1, wherein
optimizing the data structure for performing layer-wise event-routing using the neuron address index method comprising global index, layer-wise index, and neuron-group index;
ensures that all neurons within the neural network have different addresses, by using the global index, according to the neuron address index used by the entire neural network unit.

3. The event-routing method for spiking neural network of claim 1, wherein
optimizing the data structure for performing layer-wise event-routing using the neuron address index method comprising the global index, the layer-wise index, and the neuron-group index;
ensures that all neurons in each layer have different addresses, by using the layer-wise index, according to the neuron address index used by each layer unit of the neural network.

4. The event-routing method for spiking neural network of claim 1, wherein
optimizing the data structure for performing layer-wise event-routing using the neuron address index method comprising the global index, the layer-wise index, and the neuron-group index:
ensures, by using the neuron-group index, that each layer is composed of multiple neuron-groups, and that all the neurons in each group have different addresses according to the neuron address index used by each neuron-group.

5. The event-routing method for spiking neural network of claim 1, wherein
optimizing the data structure for performing layer-wise event-routing using the neuron address index method comprising the global index, the layer-wise index, and the neuron-group index:
ensure that the event data packet generated by the neuron address index method comprising the global index, the layer-wise index and the neuron-group index is composed of global address of the output neuron, wherein the operation of finding the connected neuron to change the global address to the layer-wise address uses the layer-wise neuron address.

6. The event-routing method for spiking neural network of claim 1, wherein
performing layer-wise event-routing using the LUT for each of the global index, the layer-wise index, and the neuron-group index comprises:
storing an address of layer and in-layer group to which the output neuron indexed by global address belongs, and converting the global address of the output neuron into layer-wise neuron address, through group lookup table (Group_LUT).

7. The event-routing method for spiking neural network of claim 1, wherein
performing layer-wise event-routing using the LUT for each of the global index, the layer-wise index, and the neuron-group index comprises:
storing information of each layer through layer lookup table (Layer_LUT); and
storing a minimum value of a group address included in each layer, a dimension of the layer, the number of neurons included in the layer, an index of a connection type, the number of other layers connected to the layer, and information of a dimension of a layer in a case of a three-dimensional layer.

8. The event-routing method for spiking neural network of claim 1, further comprising:
performing layer-wise event-routing using the LUT for each of the global index, the layer-wise index, and the neuron-group index comprises:
storing a hyperparameter of the kernel of the convolution layer, performing operations for determining the size of the connected layer and the address of the connected neuron in the layer, and performing synaptic weight address operation, through a connection lookup table (Connective_LUT).

9. The event-routing method for spiking neural network of claim 8, further comprising:
compressing synaptic weight data according to a global address operation for layer-wise event-routing for neuron-group index comprises:
compressing synaptic weight data by performing the same operation for connections with identical weights during event-routing of the convolution layer to increase the weight-reuse rate.

10. A neuromorphic processor for event-routing of spiking neural network comprising:
a neuron address indexing unit that optimizes a data structure for performing layer-wise event-routing using a neuron address index method comprising a global index, a layer-wise index, and a neuron-group index; and
a routing performing unit that performs layer-wise event-routing using the LUT for each of the global index, the layer-wise index, and the neuron-group index, and compresses synaptic weight data according to a global address operation for layer-wise event-routing for neuron-group index.

11. The neuromorphic processor for event-routing of spiking neural network of claim 10, wherein
the neuron address indexing unit ensures:
that all neurons within the neural network have different addresses, by using the global index, according to the neuron address index used by the entire neural network unit,
that all neurons in each layer have different addresses, by using the layer-wise index, according to the neuron address index used by each layer unit of the neural network, and
by using the neuron-group index, that each layer is composed of multiple neuron-groups, and that all the neurons in each group have different addresses according to the neuron address index used by each neuron-group.

12. The neuromorphic processor for event-routing of spiking neural network of claim 10, wherein
the routing performing unit:
comprises a group lookup table (Group_LUT), a layer lookup table (Layer_LUT), and a connection lookup table (Connective_LUT),
stores an address of layer and in-layer group to which the output neuron indexed by global address belongs, and converts the global address of the output neuron into layer-wise neuron address, through group lookup table (Group_LUT),
stores information of each layer through layer lookup table (Layer_LUT), and stores a minimum value of a group address included in each layer, a dimension of the layer, the number of neurons included in the layer, an index of a connection type, the number of other layers connected to the layer, and information of a dimension of a layer in a case of a three-dimensional layer, and
stores a hyperparameter of the kernel of the convolution layer, performs operations for determining the size of the connected layer and the address of the connected neuron in the layer, and performs synaptic weight address operation, through a connection lookup table (Connective_LUT).

13. The neuromorphic processor for event-routing of spiking neural network of claim 12, wherein
the processor compresses synaptic weight data through the connection lookup table (Connective_LUT) by performing the same operation for connections with identical weights during event-routing of the convolution layer to increase the weight-reuse rate.
